(19) United States
(12) Patent Application Publication
(10) Pub. No.: US 2020/0114697 A1
(43) Pub. Date: Apr. 16, 2020

(54) TIRE TREAD HAVING SUBMERGED VOID FEATURE WITH TAPERED ORIFICE

(71) Applicant: COMPAGINE GENERALE DES ETABLISSMENTS MICHELIN, Clemont-Ferrand (FR)

(72) Inventor: Robert C. LAWSON, Greenville, SC (US)

(21) Appl. No.: 16/626,268

(22) PCT Filed: Jun. 30, 2017
(86) PCT No.: PCT/US2017/040243

§ 371 Date: Dec. 23, 2019

(51) Int. Cl. B60C 11/12; B60C 11/03

(52) U.S. Cl. CPC B60C 11/1218; B60C 11/0306; B60C 2011/1213; B60C 11/0302; B60C 2011/1209; B60C 11/1281

(57) ABSTRACT

The present disclosure concerns tire treads including one or more particular void features. These void features include a submerged void portion (22) and a connecting portion (24). The submerged void portion (22) is submerged within a thickness of the tread. The connecting portion (24) forms a passage extending from an orifice (28) arranged along the outer side of the tread and is in fluid communication with the submerged void portion (22). The connecting portion (24) includes an outer tapering portion (26) that tapers inwardly from the orifice (28) to a narrowed portion (30) of the connecting portion (24) or passage.

### BACKGROUND

### Field

Embodiments relates generally to tire treads for tires.

### Description of the Related Art

Tires, whether pneumatic or non-pneumatic, include a tread configured to develop traction (adherence) between the vehicle and a road surface, whether during braking, acceleration, or cornering. As a tire tread wears, adherence typically changes due to changes in tread sculpture rigidity, geometry, and void volume. Dry adherence tends to improve as the tire wears while wet and snow adherence tends to degrade. Traditional sculpture tuning (changes in block length, groove width, etc.) is performed to optimize tire performances, but this type of tuning does not fundamentally change the compromises among dry and wet/snow adherence. Accordingly, there is a tradeoff throughout the life of the tire tread between dry and wet/snow traction. As a result, there is a need to develop new sculpture technologies to overcome this compromise.

### SUMMARY

Embodiments include a tire tread and in other variations a tire whereby the tire tread is operably attached to the tire. The tire tread includes a thickness bounded by an outer, ground-engaging side and a bottom side. In certain embodiments, the tire tread includes a void feature including a submerged void portion and a connecting portion. The submerged void portion is submerged within the thickness from the outer, ground-engaging side. The connecting portion forms a passage extending from an orifice arranged along the outer, ground-engaging side, the connecting portion being in fluid communication with the submerged void portion, the connecting portion including an outer tapering portion that tapers inwardly from the orifice to a narrowed portion.

### DETAILED DESCRIPTION OF THE DRAWINGS

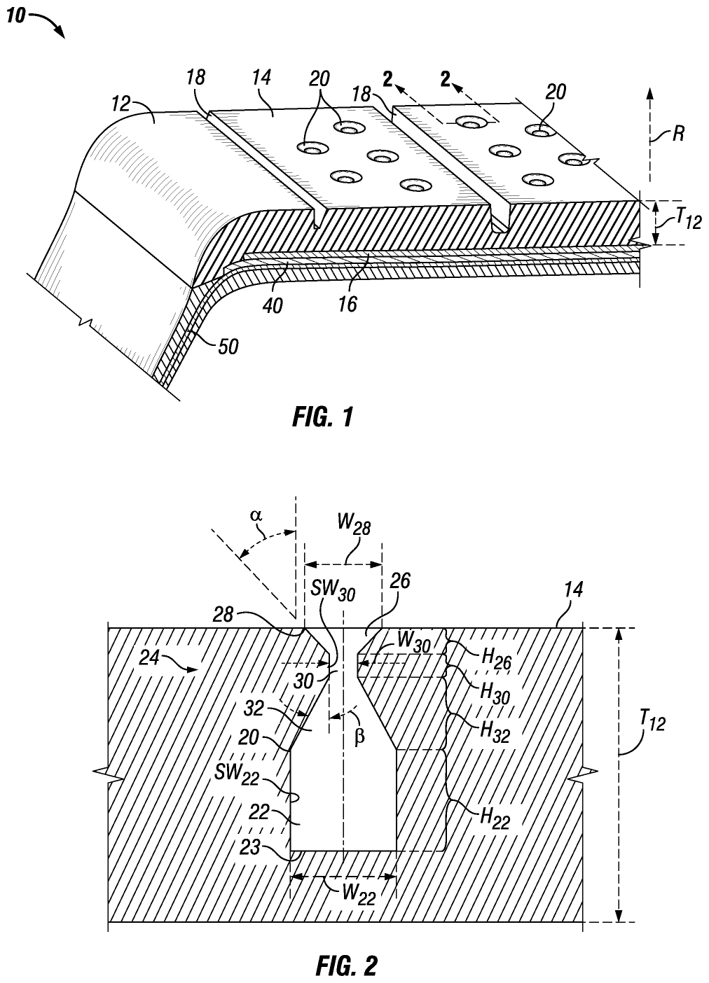

FIG. 1 is a sectional perspective view of a tire, in accordance with a particular embodiment.

FIG. 2 is a side sectional view of a void feature taken along line 2-2 in FIG. 1,

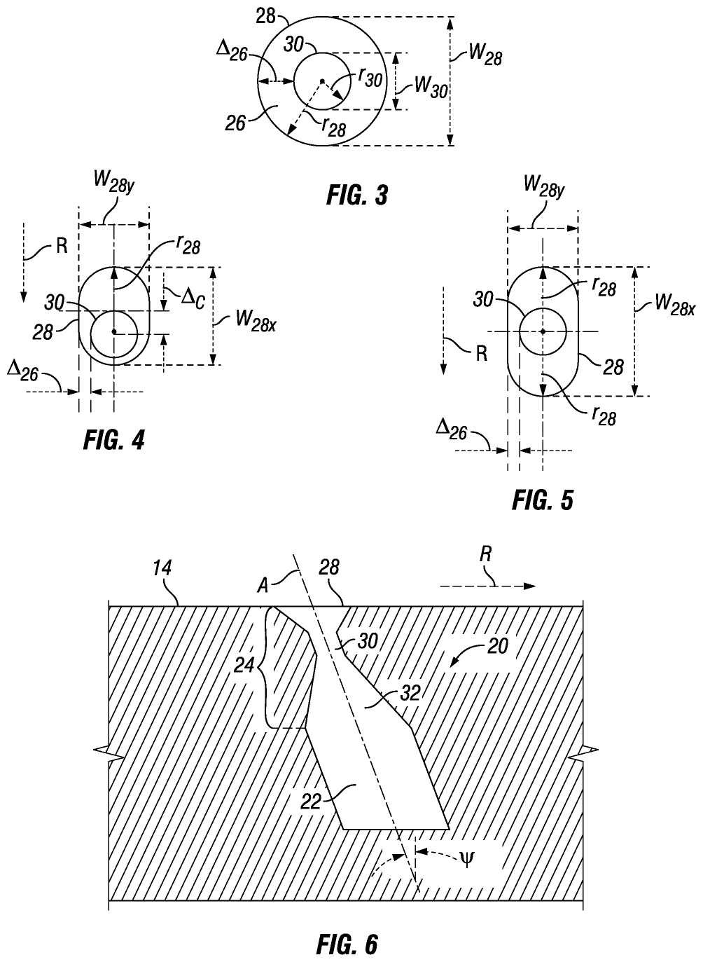

FIG. 3 is a top view of the void feature shown in FIG. 2.

FIG. 4 is a top view of a variation of the void feature shown in FIG. 2 in accordance with another embodiment.

FIG. 5 is a top view of the void feature shown in FIG. 2 in accordance with yet another embodiment.

FIG. 6 is a side sectional view of a variation of the void feature shown in FIG. 2 in accordance with another embodiment.

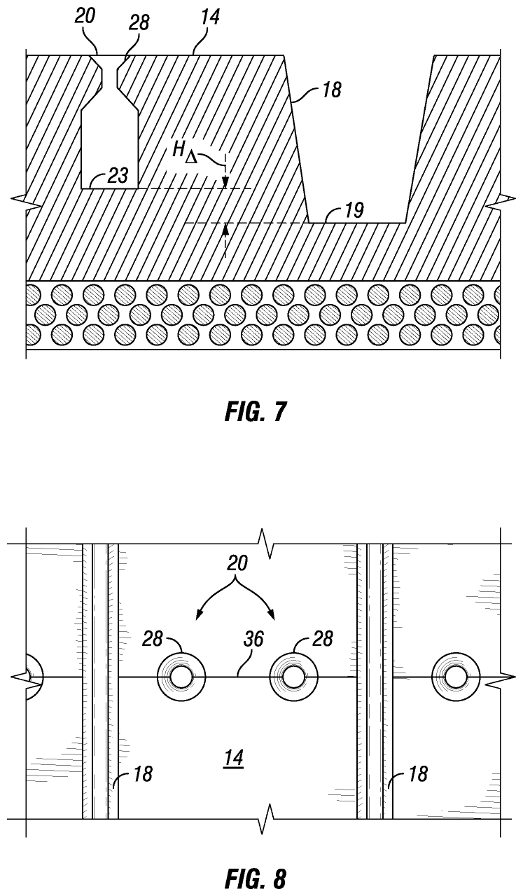

FIG. 7 is a top elevational view of a tire tread including void features generally represented in FIG. 1 together with a discontinuity forming a sipe extending through each of the void features shown in accordance with another embodiment.

FIG. 8 is a side sectional view of a tire tread including a void feature generally shown in FIG. 2 extending depthwise into the tire tread in relation to a longitudinal groove in accordance with a particular embodiment.

### DETAILED DESCRIPTION OF PARTICULAR EMBODIMENTS

This disclosure introduces a void feature that includes (1) a “hidden void” component (that is, a submerged void portion) to improve wet and snow traction in the worn state of the tire and (2) a tapered portion extending outwardly from a top of the “hidden void” component to minimize any degradations in dry traction, such as under braking, acceleration, or cornering.

Certain exemplary embodiments will now be discussed below in association with the figures.

With reference to FIG. 1, a sectional perspective view of a tire 10 is shown in accordance with a particular embodiment. The tire shown is a pneumatic tire, but the treads discussed herein may also be used on non-pneumatic tires as well (as previously noted). Tire 10 includes a tread 12 arranged overtop one or more belt plies 40 and one or more body (carcass) plies 50. Tread 12 includes various void features, including longitudinal grooves 18 and void features 20 arranged in fluid communication with an outer, ground-engaging side 14 of tread 12. Tire tread 12 has a thickness T₁₂ bounded by the outer, ground-engaging side 14 and a bottom side 16. Tread thickness may remain constant or vary across the tread. The tread thickness T₁₂ extends in a direction perpendicular to the outer, ground-engaging side 14 or to the bottom side 16. The radial direction of the tire is identified as R in this figure.

With reference to FIG. 2, a void feature 20 is shown in greater detail in a side-sectional view. The void feature 20 includes a submerged void portion 22 and a connecting portion 24. Submerged void portion 22 is submerged below (offset from) the outer, ground-engaging side 14. Connecting portion 24 includes an outer tapering portion 26 that tapers inwardly from an orifice 28 located along the outer, ground-engaging side 14 and to a narrowed portion 30. While the narrowed portion may not extend any notable distance in the direction of the tread thickness in certain variations, meaning, the narrowed portion may form a single peak of narrowness, in other variations, such as is shown according to the exemplary embodiment of FIG. 2, narrowed portion 30 extends a distance D₃₀ (which may be referred to as a length or height) in the direction of the tread thickness T₁₂. While the narrowed portion 30 may extend entirely in the direction of the tread thickness T₁₂ as is shown FIG. 2 according to one example, it may extend partially in the direction of the tread thickness (represented by a vector component). It can be said that connecting portion 24 is in fluid communication with the submerged void portion 22. In being in fluid communication with the submerged void portion 22, connecting portion 24 may extend directly to the submerged void portion 22 (not shown) or to an inner tapering portion 32, which is shown in the present embodiment to taper outwardly from the narrowed portion 30 of the connecting portion 24.

With continued reference to FIG. 2, outer tapering portion 26 and the inner tapering portion 32 each taper linearly. It is appreciated, however, that each of the outer tapering portion and the inner tapering portion, when present, may taper in any desired linear or non-linear manner. In the embodiment shown, outer tapering portion 26 tapers by an angle α while inner tapering portion 32 tapers by an angle R. Each such angle is measured relative to the direction of the tread thickness. It is appreciated that each may be the same angle or different angles, and may range from 0 to 45 degrees. Also in the embodiment shown, each angle α, β remains constant as each outer and inner tapering portion 26, 32 extends around the void feature 20. In other embodiments, any such angle may instead vary as the corresponding outer or inner tapering portion extends around the void feature.

As for shape, in cross-section, each of the narrowed portion 30 and the submerged void portion 22 are circular in the exemplary embodiment shown in FIG. 2, and, when considering the corresponding volumetric shape of each, each forms a circular cylinder. It is appreciated, however, that each may form any desired cross-sectional and volumetric shape in these or any other embodiment. For example, each may form a cross-sectional shape forming a triangle, rectangle, or oval, while each forms a corresponding volumetric shape comprising a prism, cube, and elliptic cylinder. It is also noted that each of the narrowed portion 30 and the submerged void portion 22 as shown in FIG. 2 are of constant cross-section as each extend in the direction of the tread thickness T₁₂. In other variations, however, the cross-section for any of the narrowed portion and/or of the submerged void portion may vary for any distance as desired.

Each of the submerged void portion and the narrowed portion has a width or more generally a transverse dimension that may remain constant or variable around the void feature and as each extends in the direction of the tread thickness. For example, with reference to FIG. 2, each of the submerged void portion 22 and the narrowed portion 30 has a width W₂₂, W₃₀, respectively. In this embodiment, each width W₂₂, W₃₀ remains constant around the void feature 20 as each extends in the direction of the tread thickness by a height H₂₂, H₃₀, respectively. This is because each of the submerged void portion 22 and the narrowed portion 30 forms a circular cylinder. Accordingly, in such instances, each width W₂₂, W₃₀ is a diameter. In extending the direction of the tread thickness, it can be said that each of the widths W₂₂, W₃₀ extend (are measured) in a direction parallel to the outer, ground-engaging side 14 or to the bottom side 16, or, in other words, perpendicular to the direction of the tread thickness T₁₂. It is apparent that the submerged void width W₂₂ is greater than the narrowed portion width W₃₀. While the submerged void width may more generally be equal to or greater than the narrowed portion width in any embodiment, in particular instances, such as is exemplarily shown, the submerged void portion width is greater than the narrowed portion width. Also, while the submerged void portion width may be greater than the narrowed portion width by any amount, in particular instances, the submerged void portion is no greater than twice the width of the narrowed portion.

It is noted that the submerged void portion may include a bottom arranged opposite the narrowed portion and one or more side walls depending on its shape. For example, with reference again to FIG. 2, the submerged void portion 22 includes a bottom 23, where one or more side walls SW₂₂ together extend both around a perimeter of the bottom 23. Each of the one or more side walls SW₂₂ also extend in a direction away from the bottom 23 and towards the outer, ground-engaging side 14, that is, in the direction of the tread thickness T₁₂. In certain instances, such as is shown in FIG. 2, a single sidewall SW₂₂ extends from bottom 23. This is because submerged void portion 22 is a cylinder, meaning, it comprises a single side wall SW₂₂ extending around the bottom to define a perimeter of the cylinder. In this instance, side wall SW₂₂ extends linearly in the direction of the tread thickness. It is appreciated that in other variations of the void feature, any one or more side walls may also extend linearly in the direction of the tread thickness. It is appreciated that the junction between any side wall SW₂₂ and the bottom 23 may be rounded or filleted as desired to reduce stress concentrations that may otherwise promote cracking.

It is noted that in instances where the narrowed portion extends for a distance, it includes one or more side walls depending on its shape. For example, with reference again to FIG. 2, the narrowed portion 30 includes a side wall SW₃₀ extending around a perimeter of the narrowed portion 30. Side wall SW₃₀ also extends in a direction away from the bottom 23 and towards the outer, ground-engaging side 14, that is, in the direction of the tread thickness T₁₂. In certain instances, such as is shown in FIG. 2, a single sidewall SW₂₂ extends from bottom 23. This is because narrowed portion 30 is a cylinder, meaning, it comprises a single side wall SW₃₀ extending around the narrowed portion 30 to define a perimeter of the cylinder. In this instance, side wall SW₃₀ extends linearly in the direction of the tread thickness. It is appreciated that in other variations of the void feature, any one or more side walls of the narrowed portion may also extend linearly in the direction of the tread thickness.

It is appreciated that each of the narrowed portion and the submerged void portion may have a variable width or more generally a variable transverse dimension around the void feature. Accordingly, in certain instances, any width or transverse dimension of any narrowed portion or the submerged void portion may taper, undulate, or otherwise vary, where any portion of any side wall may extend at least partially in a direction other than the direction of the tread thickness along any linear or non-linear path. This direction can be described as being biased relative to the direction of the tread thickness by an angle greater than zero degrees and less than 90 degrees.

With reference to FIG. 3, a top view of the outer tapering portion 26 extending inwardly from orifice 28 to narrowed portion 30, in accordance with the embodiment shown in FIG. 2. In particular, it is shown that each of the orifice 28 and narrowed portion 30 are each characterized as having circular cross-sections taken in a direction perpendicular to the direction of the tread thickness. It is also recognized that each are concentric about a common axis. It follows that the width W₂₈, W₃₀ for each of the orifice 28 and narrowed portion 30 are each constant around the void feature, and more specifically, each width W₂₈, W₃₀ represents a diameter. It also follows that the difference between each corresponding radius r₂₈, r₃₀ is identified as Δ₂₆, which represents the width of one side of the outer tapering portion 26. It is appreciated that this band width Δ₂₆ of outer tapering portion 26 may be any distance, and may remain constant or vary around the narrowed portion 30 and the void feature 20. For example, in particular instances, for the embodiment shown or any other, the band width (Δ₂₆) of outer tapering portion 26 is 1 to 1.5 millimeters (mm), and in instances where the band width varies the maximum is 1 to 1.5 mm while the minimum may be 1 mm to zero or substantially zero.

It is noted that the submerged void portion has been added to improve worn stage wet and snow performance by introducing additional void volume as the tread wears to overcome the loss in void volume that otherwise would occur in worn tread stages. Because the additional void is not required in the new and early worn stages, the submerged void is fluidly connected to the outer, ground-engaging side by a narrowed passage forming the connecting portion. However, to improve dry traction, at least a portion of the perimeter of the orifice of the connecting portion (the orifice being arranged along the outer, ground-engaging side) is tapered (linearly or non-linearly), which improves traction (the friction coefficient) and contact pressure between the tread and a ground surface. Otherwise, the edge forming the perimeter would fold and lead to tread and performance degradation. By forming oblong or elongated orifices, void formation may be controlled, where the portions of the orifice/tapering portion are not tapered or are less tapered in distance (that is, the width/bandwidth of the tapering portion is reduced) eliminate void thereby increasing contact surface ratio and reducing volumetric void in the new and early worn stages, which further improves dry traction by placing more tread on the road surface. Based upon the rotational direction of the tire, positioning the elongated portion of the oblong orifice in a certain direction and tapering the elongated portion as discussed herein will improve dry braking, dry driving, and/or dry cornering as desired. For example, braking performance is improved when the orifice and tapering portion extends outwardly from the narrowed portion in the direction opposite of forward tread rotation and/or when the void feature is inclined in the direction of opposite forward tread rotation. By further example, drive (acceleration) performance is improved when the orifice and tapering portion extends outwardly from the narrowed portion in the direction of forward tread rotation and/or when the void feature is inclined in the direction of forward tread rotation. In is noted that contact surface ratio (CSR) is a way of quantifying or evaluating surface void, where contact surface ratio represents the area of tread surface for contacting the ground that is present within the perimeter of a contact patch along the outer, ground-engaging side of the tread divided by total area within the perimeter of the contact patch. The area within the contact patch that does not form the outer tread surface (i.e., contact surface) is considered surface void. As a tire tread wears to its base in a completely worn state where all tread voids are eliminated, the contact surface ratio would approach a value of one. It is further noted, however, that certain aspects of the void feature may be further altered, such as employing particular shapes for certain features, which may form elongated features extending outwardly from the narrowed portion in any one or more directions, and as such may result in offsetting any feature relative to another, and/or angling any feature relative to the direction of the tread thickness (or to the radial direction of any tire upon which the tread is installed) to tune the tread sculpture for the purpose of improving any particular tire performance measure.

By tapering the orifice by way of the narrowing portion in either direction of rotation, or any direction there between, improved tire performance may be achieved. For example, by tapering the orifice such that the tapering portion extends outwardly from the narrowed portion in a direction opposite the direction of tire rotation, or otherwise changing its shape, dry braking can be improved, where the degradation normally associated with the presence of the submerged void portion is reduced. In one example, with reference to FIG. 5, a variation of the void feature 20 of FIG. 3 is shown, where the circular orifice 28 is now in an elongated form, forming an oval or ellipse. This may be achieved by narrowing the tapering distance or width/bandwidth of the tapering portion at certain locations around the otherwise circular orifice (such as where W₂₈ₓ equals to W₂₈ in the embodiment shown in FIG. 3), or by elongating certain portions of the narrowing portion around the otherwise circular orifice. In FIG. 5, the elongated portion of the orifice 28 or of the tapering portion 26 extends in both the direction of rotation R and in the direction of counter-rotation (the direction opposite of rotation R). In this arrangement, a major axis of the oval extends in the longitudinal direction of the tread (the X-direction of the tread), while the major and minor axes of the oval intersect at the center of the narrowed portion 30. In other words, the origin of the oval is aligned with the origin of the narrowed portion 30. In this embodiment, the oval-shaped orifice 28 is symmetrically oriented relative to the narrowed portion 30, which is beneficial for use on non-directional tire treads (that is, a tire can be mounted and rotate forward in either rotational direction) by allowing the dry braking benefits of an elongated orifice to occur regardless of the mounting orientation of a tire. In lieu of elongating the orifice in both circumferential (rotational) directions, for a directional tire (that is, a tire designed to mount and rotate forward in only one rotational direction) the orifice may be elongated only in on rotational direction, such as in a direction opposite the direction of forward rotation for the purpose of improving dry braking. For example, this is shown in one embodiment in FIG. 4, where an elongated orifice 28 forming an oval is shown, where the maximum taper distance or width/bandwidth of the tapering portion 26 is provided in the direction opposite the direction of intended tread rotation R, while the other portions of the tapering portion are of a reduced width or band width Δ₂₆. As a result, the resulting oblong orifice 28 is shown offset relative to the center of narrowed portion 30. More specifically, the minor axis of the oval-shaped orifice 28 is offset by a distance Δ_{C} from the center of the narrowed portion 30. It is appreciated that a symmetric or asymmetric oval may be formed. It is also appreciated that in each embodiment shown in FIGS. 4 and 5, the width of the orifice 28 taken in the direction of the major axis (X-direction of the tread) is W₂₈ₓ while the width of the orifice 28 measured in the direction of the minor axis (Y-direction of the tread) is W_{28y}. Likewise, the band width Δ₂₆ of the outer tapering portion 26 necessarily varies around the void feature 20 in each embodiment shown. In the embodiments shown in FIGS. 4 and 5, while a common radius r₂₈ is maintained along at least a portion of each orifice 28 between each embodiment shown in FIGS. 3 to 5, meaning, other portions of the tapering portion 26 in each embodiment are reduced while maintaining the same distance r₂₀, in other variations, r₂₀ may increase or decrease between any embodiment shown in FIGS. 3 to 5, as may the other portions of the tapering portion width or band width Δ₂₆. It is appreciated that shaping the orifice to be an oval reduces the presence of stress concentrations, but still, it is appreciated that in lieu of an oval or ellipse, the orifice may employ any other elongate shape, such as a rectangle or the like.

In an effort to further tune the tread sculpture and improve dry braking performance and/or wear performance, the void feature, in whole or in part, may be inclined away from the direction of intended forward rotation as the void feature extends towards the outer, ground-engaging side of the tread. This is exemplified in an exemplary embodiment shown in FIG. 6. In this embodiment, for void feature 20, the submerged void portion 22 and its side wall SW₂₂ together with the narrowed portion 30 and its side wall SW₃₀ are inclined by an angle in a direction opposite the intended direction of forward rotation R of the tire tread as each such side wall SW₂₂, SW₃₀ extends toward the outer, ground-engaging side 14. By doing so, when this portion of the tread is arranged in a contact patch (footprint) on a road surface, angle ψ is inclined in the direction of forward vehicle travel to benefit braking performance. In addition, an inclined axis A (inclined by angle ψ) extends through each of the submerged void portion 22 and the narrowed portion 30, and more specifically, inclined axis A extends through the center of each of the submerged void portion 22 and the narrowed portion 30. It is noted that employing any non-zero angle ψ may render the tire sculpture or tire tread directional, where the tire tread is designed to properly operate when rotating in only one of the two possible rotational directions. This may be achieved when a significant quantity of the void features are inclined by a non-zero angle ψ is one of either rotational directions. By doing so, the traction benefits of inclining each void feature is compounded and may generally be maximized. However, it is appreciated that void features inclined by a non-zero angle ψ may still be employed in a non-direction tread design, such as by alternating the arrangement of void features inclined by positive and negative non-zero angles ψ across the tread width. In other variations, it is appreciated that even in an inclined state, for any void feature, each side wall of any narrowed portion or submerged void portion may extend in the same direction, that is, at the same angle, or each may be arranged at different angles. Also, the volumetric shape of each of the narrowed portion and the submerged void portion may form any desired shape, and may extend be tapered, variable, or constant in width as each extends through the tread thickness. It is also appreciated that in other variations, the common axis may extend non-centrally through any one or each of the narrowed portion and the submerged void portion.

It is appreciated that void features may be arranged along any portion of the tire tread, such as any tread block or rib located at any location across the tread, from the shoulder area to an interior portion of the tread, such as along any center or intermediate ribs to allow for increased transversal void without the traditional risk of turbulence at the intersection of longitudinal grooves and transversal void features. Further, any void feature may be arranged in association with any elongate discontinuity, such as a groove or sipe. Arranged in association means that any elongate discontinuity may intersect or extend into or from any one or more void features. For example, with reference to an exemplary embodiment in FIG. 7, an elongate discontinuity 36 is shown extending transversely across the void features 20 and at least across the connecting portion thereof, the discontinuity being a sipe.

It is appreciated that the bottom of any void feature may be arranged at any depth of the tread thickness. For example, it may be arranged at a bottom side of a tread or anywhere in between the outer, ground-engaging side and the bottom side. In an exemplary embodiment shown in FIG. 8, the bottom 23 of a void feature 20 is shown to be offset towards the outer, ground-engaging side 14 by a distance H_{Δ} relative to a bottom 19 of a groove 18, where distance H_{Δ} may be any desired distance, such as 0.5 mm or 50% the height of groove 18, for example. While the overall height of the void feature 20 may range as desired in any embodiment, in certain instances the void feature 20 extends a height equal to 50 to 100% the height of a groove 18.

To the extent used, the terms “comprising,” “including,” and “having,” or any variation thereof, as used in the claims and/or specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the embodiments. Ranges that are described as being “between a and b” are inclusive of the values for “a” and “b” unless otherwise specified.

While various improvements have been described herein with reference to particular embodiments thereof, it shall be understood that such description is by way of illustration only and should not be construed as limiting the scope of any claimed invention. Accordingly, the scope and content of any claimed invention is to be defined only by the terms of the following claims, in the present form or as amended during prosecution or pursued in any continuation application. Furthermore, it is understood that the features of any specific embodiment discussed herein may be combined with one or more features of any one or more embodiments otherwise discussed or contemplated herein unless otherwise stated.

1. A tire tread comprising:
a thickness bounded by an outer, ground-engaging side and a bottom side;
a void feature including a submerged void portion and a connecting portion, the submerged void portion being submerged within the thickness from the outer, ground-engaging side and the connecting portion forming a passage extending from an orifice arranged along the outer, ground-engaging side, the connecting portion being in fluid communication with the submerged void portion, the connecting portion including an outer tapering portion that tapers inwardly from the orifice to a narrowed portion,
where the submerged void portion extends in a direction away from the outer, ground-engaging side to terminate at a bottom and where one or more side walls together extend both around a perimeter of the bottom and in a direction away from the bottom and towards the outer, ground-engaging side,
where the direction by which the one or more side walls of the submerged void portion extends is biased relative to the direction of the tread thickness by an angle greater than zero degrees and less than 90 degrees.

2. The tire tread of claim 1, where the connecting portion includes an inner tapering portion that tapers outwardly from the narrowed portion to the submerged void portion.

3. The tire tread of claim 1, where the narrowed portion extends a distance in the direction of the tread thickness.

4. The tire tread of claim 3, where the narrowed portion is cylindrical.

5. The tire tread of claim 1, where the submerged void portion is cylindrical.

6. The tire tread of claim 1, where the submerged void portion has a width and the narrowed portion has a width, each width extending in a direction perpendicular to the direction of the tread thickness, where the width of the submerged void portion is greater than the width of the narrowed passage.

7. (canceled)

8. The tire tread of claim 1, where the direction by which the one or more side walls of the submerged void portion extends is the direction of the tread thickness.

9. (canceled)

10. The tire tread of claim 1, where each of the one or more side walls extends linearly in the direction away from the bottom.

11. The tire tread of claim 1, where the narrowed portion includes one or more side walls together extending both around a perimeter of the narrowed portion and in a direction away from the submerged void and towards the outer, ground-engaging side.

12. The tire tread of claim 11, where the direction by which the one or more side walls of the narrowed portion extends is the direction of the tread thickness.

13. The tire tread of claim 12, where the direction by which the one or more side walls of the narrowed portion extends is biased relative to the direction of the tread thickness by an angle greater than zero degrees and less than 90 degrees.

14. The tire tread of claim 13, where each of the one or more side walls of the narrowed portion extends linearly in the direction away from the bottom.

15. The tire tread of claim 1, where the narrowed portion includes one or more side walls together extending both around a perimeter of the narrowed portion and in a direction away from the submerged void and towards the outer, ground-engaging side, where each of the one or more side walls of the submerged void portion and of the narrowed portion are inclined in a direction opposite a direction of intended forward rotation of the tire tread as each side wall extends toward the outer, ground-engaging side.

16. The tire tread of claim 15, where an inclined axis extends through each of the submerged void portion and the narrowed portion.

17. The tire tread of claim 16, where the inclined axis extends through the center of each of the submerged void portion and the narrowed portion.

18. The tire tread of claim 1, where the orifice is elongated in a direction opposite a direction of intended forward rotation of the tire tread.

19. The tire tread of claim 18, where the orifice is also elongated in the direction of forward rotation of the tire tread.

20. The tire tread of claim 1 further comprising:
an elongate discontinuity extending transversely across the void feature and at least across the connecting portion thereof.

21. The tire tread of claim 20, where the discontinuity is a sipe.
